(19) United States
(12) Patent Application Publication
(10) Pub. No.: US 2005/0013605 A1
(43) Pub. Date: Jan. 20, 2005

(54) Digital camera

(75) Inventor: Hiroaki Kubo, Muko-Shi (JP)

Correspondence Address: BURNS DOANE SWECKER & MATHIS L L P, POST OFFICE BOX 1404, ALEXANDRIA, VA, 22313-1404, US

(73) Assignee: Minolta Co., Ltd., Osaka (JP)

(21) Appl. No.: 10/917,378

(22) Filed: Aug. 13, 2004

Related U.S. Application Data
(63) Continuation of application No. 09/594,591, filed on Jun. 15, 2000.

(30) Foreign Application Priority Data
Jun. 28, 1999 (JP) 11-181806

(51) Int. Cl. G03B 13/02

(52) U.S. Cl. 396/374

(57) ABSTRACT

A digital camera provided with a mirror to reflect part of the object image light and transmit the remaining light, a finder to capture part of the reflected light, an image sensor to capture and photoelectrically convert the remaining transmitted light to image signals, and a display monitor for displaying the image signals captured by the image sensor as a display image. The digital camera is provided with an eyepiece shutter for shielding the eyepiece unit of the finder when the display monitor is used, or when the image sensor is used.

### CROSS-REFERENCE TO RELATED APPLICATIONS

This application is based on Patent Application No. 11-181806 filed in Japan, the content of which is hereby incorporated by reference.

### BACKGROUND OF THE INVENTION

1. Field of the Invention

The present invention relates to a digital camera for converting light from a photographic object into image signals and displaying these image signals, and specifically relates to a digital camera provided with an optical finder.

2. Description of the Related Art

In single lens reflex cameras, the light passing through a taking lens is split by a prism, or entirely reflected by a quick-return mirror, and directed to an optical finder. This arrangement is advantageous in that an optical image identical to the optical image of the photographed object can be inspected from the eyepiece window. However, when photometric sensor is provided to measure the luminance of an object on an optical path diverged from the optical path of the light directed to the optical finder, light unrelated to the object luminance enters the photometric sensor through the optical finder from the eyepiece window (hereinafter referred to as “harmful light”), thereby causing errors in the photometric data. It has been conventionally proposed to resolve this problem via art to prevent harmful light from entering the photometric sensor by shielding the eyepiece window via an eyepiece shutter (Japanese Laid-Open Patent Nos. HEI 6-242493 and HEI 8-43884).

In digital cameras provided with an optical finder of the single lens reflex type and an electronic viewfinder comprising a liquid crystal display (LCD) or the like as a viewfinder, the object image from the taking lens is directed to an image sensing unit such as a charge-coupled device (CCD) even during the standby or pre-photographic period. Then, the image sensing unit video captures the object, so the object may be inspected by displaying the captured image on the electronic viewfinder.

When the electronic viewfinder is used, harmful light from the eyepiece window reaches the image sensing unit via the optical finder because the optical finder is not being used, so as to adversely affect the image quality of the monitor image on the electronic viewfinder. Even when the photographic object is photographed while being inspected on the electronic viewfinder, harmful light from the eyepiece window enters via the optical finder during exposure by the image sensing unit, and adversely affects the quality of the photographed image causing exposure error.

Accordingly, one object of the present invention is to prevent the entrance of harmful light from the unused optical finder when the electronic viewfinder is used to preview the image in a digital camera provided with both an electronic viewfinder and an optical finder. This prevention eliminates the concern of adversely affecting the quality of the monitor image on the electronic viewfinder.

Another object of the present invention is to provide a digital camera which eliminates concern of adversely affecting the quality of the photographed image even when a photograph is taken while viewing the photographic object via the electronic viewfinder.

### SUMMARY OF THE INVENTION

These objects are attained by a digital camera comprising an image sensor for sensing an object image; an eyepiece for viewing an object; a display for displaying an object image sensed by the image sensor; a selector for selecting a mode for viewing on object on the display; a shield member for shielding the eyepiece; and a controller for moving the shield member to block the eyepiece when a mode is selected via the selector to view an object on the display.

In this construction, since the movement of the shield member is controlled so as to block the eyepiece when a mode is selected for viewing an object via a display image on the display, it eliminates the problem of harmful light entering the image sensor from the eyepiece and adversely affecting the quality of the monitor image on the display.

In this instance, when the selector is, for example, a slide switch, the controller may comprise a movement transmitting member which moves the shield member between an eyepiece open position and an eyepiece closed position in conjunction with the sliding movement of the slide switch.

The movement transmitting member may comprise a contact member fixedly attached to the sliding part of a slide switch; an arm, one end of which contacts and is driven by the contact member and the other end of which moves the shield member; and a spring for imparting a force on the arm in the direction of contact with the contact member.

This digital camera is provide with a detector for detecting the exposure period of the image sensor, and the controller controls the opening and closing of a shield member so as to block the eyepiece during the exposure period detected by the detector.

The controller is provided with a position switching member for switching the shield member between an eyepiece open position and an eyepiece closed position, and a driver for controller the drive of the position switching member.

### BRIEF DESCRIPTION OF THE DRAWINGS

In the following description, like parts are designated by like reference numbers throughout the several drawings.

FIG. 1 is a structural view of a digital camera of a first embodiment of the present invention;

FIGS. 2(a) and 2(b) are external views of the back of the digital camera of the first embodiment, wherein FIG. 2(a) is an external view of the optical finder mode, and FIG. 2(b) is an external view of the electronic monitor mode;

FIG. 3 shows the mechanism of the eyepiece shutter in the first embodiment;

FIG. 4 is a block diagram of the image sensing process in the digital camera of the first embodiment;

FIGS. 5(a), 5(b) and 5(c) illustrate the operation during photography by the digital camera of the first embodiment, wherein FIG. 5(a) shows the operation during the optical finder mode, FIG. 5(b) shows the operation during the electronic monitor mode, and FIG. 5(c) shows the operation when a shutter is pressed from the electronic monitor mode;

FIG. 6 illustrates the mechanism of the eyepiece shutter in the digital camera of a second embodiment;

FIG. 7 is a block diagram of the image sensing process in the digital camera of the second embodiment; and

FIGS. 8(a)-8(d) illustrate the various operations in the optical finder mode of the second embodiment, wherein FIG. 8(a) shows the operation when switch S1 is ON, FIGS. 8(b) and 8(c) show the operation when switch S2 is ON, and FIG. 8(d) shows the operation thereafter.

### DETAILED DESCRIPTION OF THE PREFERREED EMBODIMENTS

The embodiments of the digital camera are described hereinafter with reference to the accompanying drawings.

First Embodiment

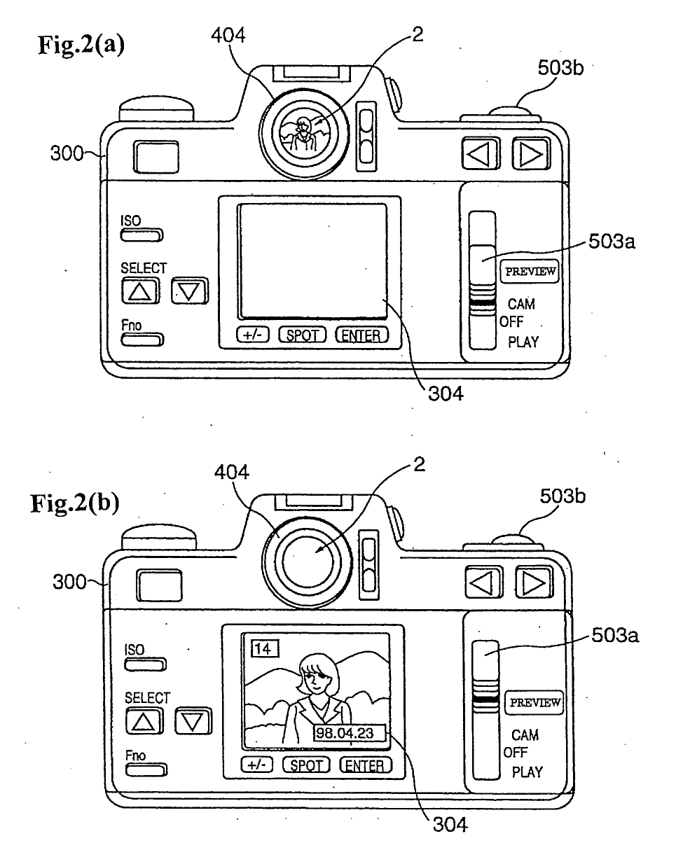

FIG. 2 shows an exterior view of the back side of a digital camera of the first embodiment. FIG. 2(a) is an exterior view during the optical finder mode. FIG. 2(b) is an external view during the electronic monitor mode. In FIGS. 2(a) and 2(b), a finder window 404 comprising an optical finder eyepiece is provided in the top center of the back side of a camera body 300. Below the finder window 404 is provided a display monitor 304 such as an LCD or the like. The display monitor 304 reproduces and displays image recorded on a recording medium in reproduction mode (PLAY mode). On the other hand, in the recording mode (REC mode), the display monitor 304 functions as an electronic viewfinder, and displays a video image of a photographed object during standby. In the drawing, a main switch 503a is provided on the right side of the display monitor 304 and comprises a slide switch which functions as a selector switch for both power ON/OFF and RECORD/PLAY modes. Above the main switch 503a on the top of the camera body 300 is provided a shutter button 503b for initiating photography. Various other operation switches are provided at suitable locations.

The main switch 503a sets the power ON and RECORD modes by sliding the from the power OFF position upward from the center, and sets the power ON and PLAY modes by sliding from the power OFF position downward from the center. In setting the RECORD mode, the optical finder and the electronic viewfinder may be switchably used. This switch setting is accomplished by closing the eyepiece shutter 2 and switching to the preview position to turn ON the display monitor 304, and opening the eyepiece shutter 2 and switching to the CAM position to turn OFF the display monitor 304.

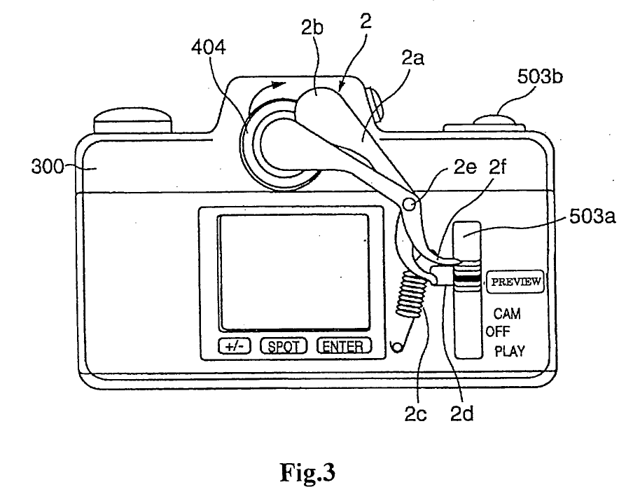

In FIG. 2(a), the main switch 503a is set at the CAM position, and the eyepiece shutter 2 is open. These settings set the optical finder mode using the finder 400. In FIG. 2(b), the main switch 503a is set at the preview position, and the eyepiece shutter 2 is closed. These settings set the electronic monitor mode using the display monitor 304. At this time, the eyepiece shutter 2 functions to prevent the harmful light from entering the finder 400. In the first embodiment, the construction shown in FIG. 3 is used as the construction for switching modes.

FIG. 3 shows the mechanism of the eyepiece shutter of the digital camera 1 of the first embodiment. Although the eyepiece shutter 2 is actually within the camera body 300, the periphery of the shutter is indicated by solid lines in the drawing to facilitate the description. That is, the mechanism of the eyepiece shutter 2 is a mechanism for mechanically opening and closing the eyepiece shutter 2 in conjunction with switching the position of the main switch 503a. The mechanism of the eyepiece shutter 2 comprises an arm 2a driven by the main switch 503a, and a shield 2b connected to the arm 2a. The shield 2b is movable between a standby position which opens the finder window 404, and a shield position which closes the finder window 404. The arm 2a is supported so as to rotatably pivot about a support point 2e within the camera body 300, and the side opposite the linkage with the movable shield 2b is normally forced in a clockwise direction in the drawing via a suitable tension imparted by a spring 2c. The end 2f of the arm 2a touches a contact 2d protruding from the main switch 503a, and is removable from this contact. When the main switch 503a is set at the preview position by a user sliding the main switch 503a in the upward direction in the drawing, a lifting force is generated by the contact 2d touching the end 2f of the arm 2a. Accordingly, at this time, the arm 2a is driven in rotation in a counterclockwise direction in the drawing about the pivot point 2e against the tension of the spring 2c, such that the shield 2b overlays the finder window 404 so as to close the window. Since the main switch 503a is a slide switch, it is capable of click-stopping at each position, i.e., preview position, CAM position, power OFF position, PLAY position. The tension of the spring 2c is set such that positional displacement of the main switch 503a is not caused by the pulling of the spring 2c. When a user sets the switch at the CAM position by sliding the mains switch 503a downward in the drawing, the lifting force imparted by the contact 2d on the arm 2a is released. Accordingly, at this time, the arm 2a is driven in rotation in a clockwise direction in the drawing about the pivot 2e, and the shield 2b is moved from the finder window 404 to open the window 404. When the main switch 503a is set at the OFF and PLAY positions, the arm 2a is removed from the contact 2d by a user sliding the main switch 503a in a downward direction in the drawing. Accordingly, at this time, the arm 2a is driven in rotation in a clockwise direction in the drawing about the pivot point 2e until it comes into contact with a stopper (not shown in the drawing) via the tension of the spring 2c. As a result, the shield 2b maintains the finder window 404 in the open state. When the camera is being manufactured, the various setting positions of the main switch 503a can be changed to optionally change the open and closed state of the finder window 404.

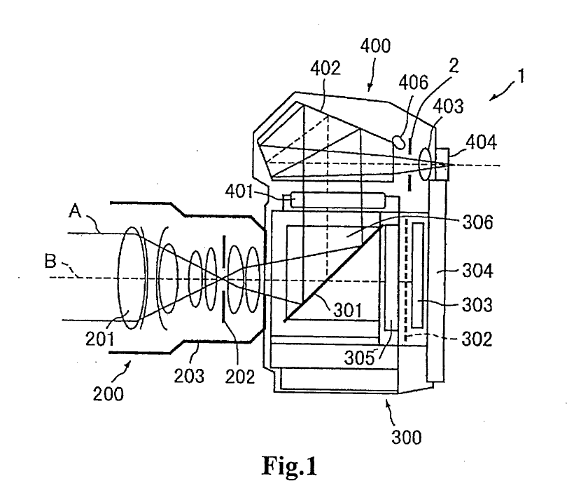

FIG. 1 is a structural view of the digital camera of the first embodiment. The digital camera 1 of the first embodiment, is a single lens reflex type camera, and basically comprises a box-like camera body 300, and a removable taking lens 200 attached to the camera body 300, as shown in FIG. 1. A finder 400 is provided at the approximate center on the top of the camera body 300.

The taking lens 200 transmits the reflected light (entrance light) A from the object under a light source not shown in the drawing to the image sensing surface within the camera body 300, ands is installed in the approximate center on the front side of the camera body 300. The taking lens 200 is provided with an image sensing optical system 201 comprising a plurality of lens elements, and an optical stop 202 for restricting the amount of entrance light through the image sensing optical system 201. The image sensing optical system 201 and the optical stop 202 are supported at predetermined positions within the lens barrel 203.

The camera body 300 is a dark box for capturing an object image via the taking lens 200. The camera body 300 photoelectrically converts the object image to image signals via a photoelectric conversion element, and subjects these image signals to predetermined processing, then records the data on a recording medium such as a memory card or the like. The camera body 300 regenerates the recorded image signals.

Within the camera body 300 is disposed an image sensor (photoelectric conversion element) 303 such as a CCD area sensor at a position near the back surface on the optical axis B of the taking lens 200. The image sensor 303 is an area sensor having, for example, red (R), blue (B), green (G), primary color transmission filters extending in checkered pattern band in pixel units, and is a type which reads all pixels. A shutter 302 and optical low-pass filter 305 are arranged on the front surface of the image sensor 303. The shutter 302 is a mechanical shutter such as a focal plane shutter which mechanically moves a shutter leaf. The optical low-pass filter 305 has a predetermined thickness, and eliminates moiré on the image sensor. The image sensor 303 also functions as an electronic shutter.

A mirror 301 is disposed within a mirror box 306 provided at a suitable location between the taking lens 200 and the image sensor 303 on the optical axis B, and the reflective surface of the mirror 301 is inclined 45∘° relative to the optical axis B so as to direct the object image to the finder 400 side. The mirror 301 is, for example, a half mirror which functions to reflect part of the entrance light A to the finder 400 side above (first optical path), and transmit the remaining light back to the image sensor 303 side (second optical path). A prism having the same function as the half mirror also may be used.

The finder 400 allows confirmation of the actual photographed image from the window by directing the object image projected on the image sensing surface to the finder window. The finder 400 is provided with a focusing screen 401, penta-roof prism 402 (hereinafter referred to simply as “prism”), eyepiece optical system 403, and finder window 404. The focusing screen 401 forms an image of the reflected light of the mirror 301 of the camera body 300. The prism 402 inverts the image formed by the focusing screen 401 90∘°. The eyepiece optical system 403 is disposed behind the prism 402 and forms the inverted image. The finder window 404 is arranged behind the eyepiece optical system 403. The previously mentioned eyepiece shutter 2 is arranged between the prism 402 and the eyepiece optical system 403.

A photometric sensor 406 is provided at an angle above and behind the finder 400 to measure the light passing through the prism 402. The photometric sensor 406 comprises a photodiode and the like.

In the above construction, an object image is condensed by the image sensing optical system 201 of the taking lens 200, and directed to the mirror 301 within camera body 300 via the optical stop 202. Part of the object image is reflected upward by the mirror 301, and forms an inverted image on the focusing screen 401 of the finder 400. The formed object image is inverted to a erect image by the prism 402, and directed to the finder window 404 through the shutter 2 and eyepiece optical system 403.

In the standby state, when the electronic monitor mode is set, the optical stop 202 is set at a predetermined stop value set beforehand, and the shutter 302 is opened. Then, the sensed image of the object (dynamic image) is captured to monitor the object image on the display monitor 304 by driving the image sensor 303 at predetermined period. This image is displayed on the display monitor 304, and in this way the user is able to confirm the object via the display image. On the other hand, when the optical finder mode is set, the user is able to confirm the object by looking through the finder window 404. Since the shutter 2 was set in the closed position in the electronic monitor mode, harmful light from the finder window 404 does not reach the image sensor 303 through the finder 400. Furthermore, since the shutter 302 was closed and a dynamic image was not captured by the image sensor 303 in the optical finder mode, harmful light from the finder window 404 is not a problem.

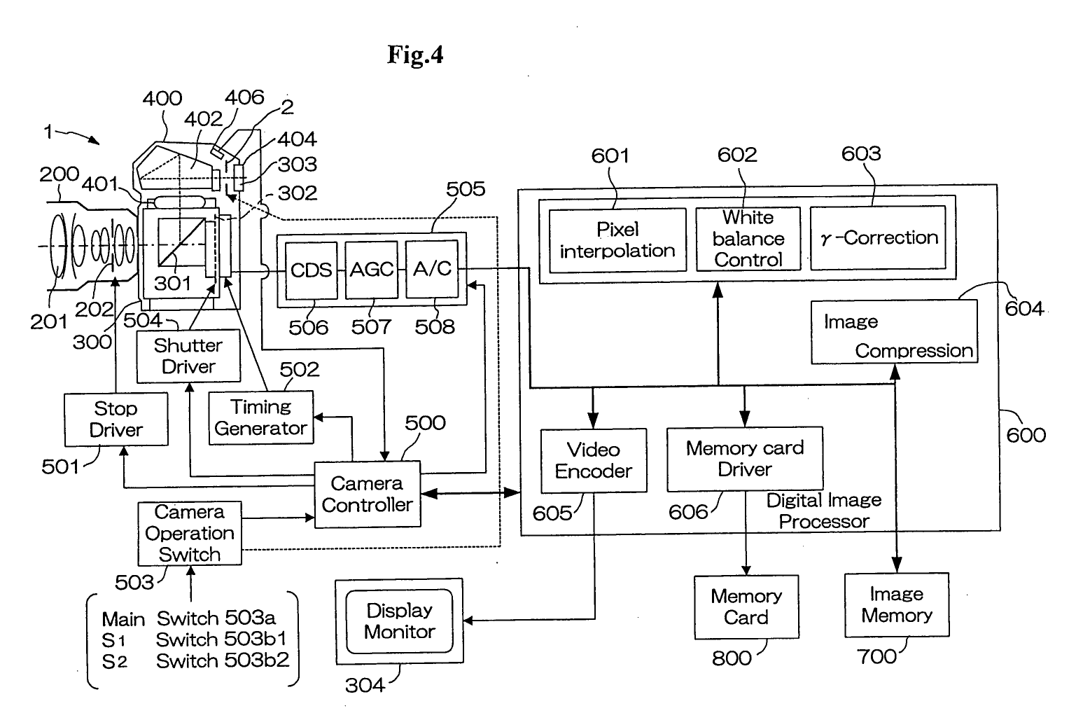

In the standby mode, when S1 switch 503b1 (refer to FIG. 4) is turned ON by pressing the shutter button 503b halfway, the exposure control value for photography (i.e., the stop value of the optical stop 202 and the shutter speed of the shutter 302) is calculated using the frame image captured by the image sensor 303. On the other hand, in the optical finder mode, the exposure control value for photography is calculated using luminance data of the object captured by the photometric sensor 406. Furthermore, the image sensing optical system 201 moved forward or back for focus adjustment via an autofocus (AF) mechanism not shown in the drawing.

Then, when the S2 switch 503b2 (refer to FIG. 4) is turned ON by fully depressing the shutter button 503b, after the exposure control value is again calculated, the optical stop 202 is set at a predetermined stop value based on the exposure control value, and the shutter 302 is once closed. Thereafter, the shutter 302 is opened only for a predetermined exposure time based on the exposure control value, and the image sensor 303 is exposed by a predetermined amount of exposure light. Since the eyepiece shutter 2 is set at the closed position at this time, harmful light from the finder window 404 does not reach the image sensor 303 through the finder 400 during the exposure, as described later.

FIG. 4 is a block diagram of the image sensing process by the digital camera of the first embodiment.

In FIG. 4, parts shown in FIGS. 1˜3 are designated by like reference numbers. In FIG. 4, a camera controller 500 performs intensive control of the photographic operations of the digital camera 1. The camera controller 500 performs photography by controlling stop driver 501, timing generator 502, and shutter driver 504 described later. The camera controller 500 controls the analog signal processor 505, digital image processor 600, and display monitor 304, and performs predetermined image processing on the photographed image. Thereafter, the camera controller 500 records the processed image on memory card 800, and displays the image on the display monitor 394.

During standby in the electronic monitor mode, the camera controller 500 extracts image signals included in a predetermined photometric area set beforehand within the screen from the image signals captured by the image sensor 302, and calculates the exposure control value for photography using these image signals. Then, the stop value of the optical stop 202 and the exposure time of shutter 302 (shutter speed) are set using the calculation result and a program line set beforehand. During standby in the optical finder mode, since the image sensor 303 is stopped, the camera controller 500 calculates the exposure control value for photography using photometric data from the photometric sensor 406 in place of image signals. Then, the stop value of the optical stop 202 and the exposure time of shutter 302 (shutter speed) are set using the calculation result and a program line set beforehand.

As described above, in the optical finder mode, the calculation of photometric data using the photometric sensor 406 is due to the following reasons. In the optical finder mode, since image information of the photographic object cannot be captured by the image sensor 304, luminance information of the photographic object must be obtained by the photometric sensor 406 within the finder optical system. On the other hand, in the electronic monitor mode, the calculation of the photometric data using the captured image of the image sensor 303 is due to the following reasons. Photometric data of a relatively wide photometric area can be obtained when the captured image is used to sample luminance data over the entire image, compared to the limited photometric data that can be obtained by the photometric sensor 406, such that more appropriate luminance data of the photographic object can be obtained. The photometric data also may be calculated using the photometric sensor 406 in the electronic monitor mode.

The stop driver 501 controls the drive of the optical stop 202 within the taking lens 200. The stop driver 501 sets the opening of the optical stop 202 at a predetermined amount of opening based on a stop value input from the camera controller 500.

The timing generator 502 controls the image sensing operation (charge accumulation based on exposure, and charge readout) of the image sensor 303. The timing generator 502 generates a predetermined timing pulse based on an image sensing control signal from the camera controller 500, and outputs the timing pulse to the image sensor 303. In the preview mode, a frame image is captured each 1/30 second by the timing generator 502, and the frame images are sequentially output to the analog signal processor 506.

The timing generator 502 accumulates a charge (i.e., the object image photoelectrically converted to image signals) in conjunction with the exposure operation by the shutter 302 during photography, and this accumulated charge is output to the analog signal processor 505. In the electronic monitor mode, each frame image captured during standby is subjected to predetermined image processing by the analog signal processor 505 and digital image processor 600, and is subsequently displayed on the display monitor 304. During photography, the sensed image is subjected to predetermined image processing by the analog signal processor 505 and digital image processor 600, and subsequently recorded on the memory card 800.

The shutter driver 504 controls the drive of the shutter 302. The shutter driver 504 controls the exposure time of the image sensor 303 via the shutter 302 based on the shutter speed input from the camera controller 500.

The camera operation switches 503 are switches for inputting operation information from the various operation buttons provided on the camera body 300 to the camera controller 500. Among the camera operation switches 503, the main switch 503a corresponds to the previously mentioned operation main switch. S1 switch 503b1, and S2 switch 503b2 correspond to half depressed operation of the shutter button 503b, and full depressed operation of the shutter button 503b. In the drawing, the dashed line extending from the camera operation switch 503b to the eyepiece shutter 2 represents the mechanical open/close operations of the eyepiece shutter 2 via operation of the main switch 503a among the camera operation switches 503.

The analog signal processor 505 subjects the image signals (analog signal batches received by each pixel of the CCD area sensor) output from the image sensor 302 to predetermined processing, and subsequently converts them to digital signals for output. The analog signal processor 505 is provided with a CDS circuit 506, AGC circuit 507, and A/D conversion circuit 508. The CDS circuit 506 reduces the reset noise included in the analog image signals. The AGC circuit 507 performs level correction of the analog image signals. The A/D conversion circuit 508 converts the analog image signals to digital image signals (hereinafter, the digital image signals are referred to as “image data”).

The digital image processor 600 subjects the image data input from the analog signal processor 505 to signal processing including pixel interpolation, white balance (WB) adjustment, gamma correction, image compression and the like. Then, the digital image processor 600 controls the reproduction display of the processed digital image on the display monitor 304, and recording to the memory card 800.

The digital image processor 600 is provided with a pixel interpolation circuit 601, white balance (WB) control circuit 602, gamma correction circuit 603, image compression circuit 604, video encoder 605, and memory card driver 606. The pixel interpolation circuit 601 interpolates data of pixel positions inadequate for the frame image for each color component R, G, B. The white balance (WB) control circuit 602 adjusts the white balance of the pixel-interpolated digital image. Gamma correction circuit 603 corrects gradient characteristics of the WB-balanced image data, such as gradient characteristics the display monitor 304 and external television monitor. The image compression circuit 604 compresses the image data comprising the photographic image to be recorded on the memory card 700. The image compression circuit 604 also expands the image data comprising the photographic image read out from the memory card 700 for reproduction display on the display monitor 304. The video encoder 605 converts the image data to be displayed on the display monitor 304 to image signals for driving the display monitor 304 (e.g., NTSC method, or PAL method), and outputs these signals to the display monitor 304. The memory card driver 606 controls the drive of the memory card 700.

In the digital camera 1 of the aforesaid construction, If the electronic monitor mode is set when the main switch 503a is set to the power ON position (i.e., not the OFF position), the image sensing operation by the image sensor 302 is repeated every 1/30 second. The sensed image of each frame is subjected to predetermined image processing including pixel interpolation, WB adjustment, and gamma correction by the analog signal processor 505 and digital image processor 600, and thereafter output to the display monitor 304. In this state, when the shutter button 503b is operated to specify photography, the exposure control value is calculated from the preview image. Then, the amount of opening of the optical stop 202 and the exposure time of the shutter 302 are controlled based on the calculated exposure control value, and a still image of the object image is captured by the image sensor 303. The captured image is subjected to image processing including pixel interpolation, WB adjustment, gamma correction, and image compression by the analog signal processor 505 and the digital image processor 600, and thereafter recorded on memory card 700.

On the other hand, if the optical finder mode is set, the image sensing operation by the image sensor 303 is not performed, and the preview image of the object is not displayed on the display monitor 304. In this state, when the shutter button 503b is operated to specify photography, first, the exposure control value is calculated from the photometric data of the photometric sensor 406. Then, the amount of opening of the optical stop 202 and the exposure time of the shutter 302 are controlled based on the calculated exposure control value, and a still image of the object image is captured by the image sensor 303. The captured image is subjected to image processing including pixel interpolation, WB adjustment, gamma correction, and image compression by the analog signal processor 505 and the digital image processor 600, and thereafter recorded on memory card 700.

The operation of the eyepiece shutter 2 in the electronic monitor mode and the optical finder mode is described below in detail.

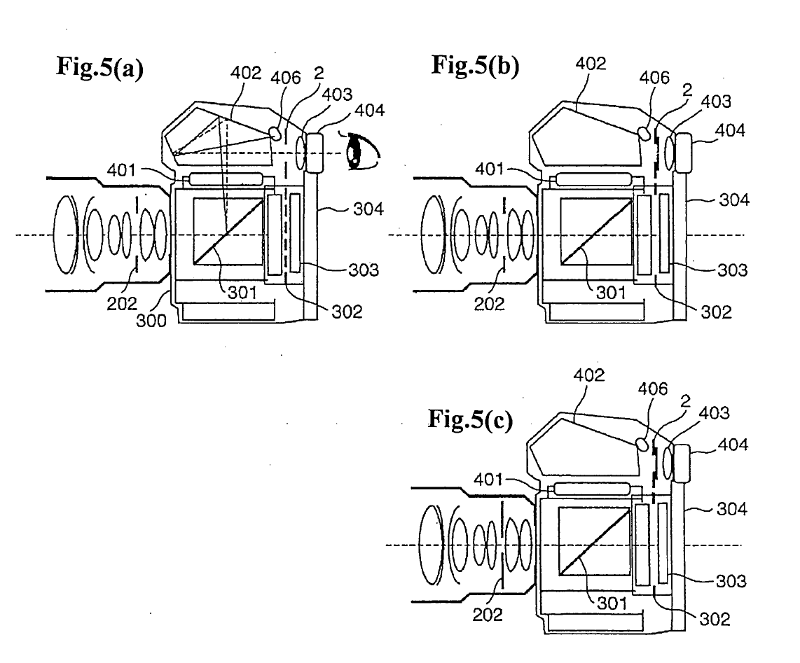

FIGS. 5(a)-5(c) illustrate the operation during photography of the digital camera 1 of the first embodiment. FIG. 5(a) shows the operation during the optical finder mode. FIG. 5(b) shows the operation during the electronic monitor mode. FIG. 5(c) shows the operation when the shutter button is pressed from the electronic monitor mode.

In FIG. 5(a), the shutter 302 is closed, and the image sensor 303 is stopped. Part of the object image light split by the mirror 301 is directed to the image sensor 303, and the remaining light is reflected by the mirror 301 and forms an image on the focusing screen 401. The formed object image is inverted by the prism 402, and the amount of light is measured by the photometric sensor 406, and is directed to the finder window 404 via the eyepiece optical system 403. At this time, since the main switch 503a is set at the CAM position specifying the optical viewfinder as shown in FIG. 3, the arm 2a does not received a lifting force from the contact 2d. Accordingly, the arm 2a is driven in rotation in a clockwise direction in FIG. 3 about the pivot point 2e via the tension of the spring 2c, and the shield 2b is removed from the overlay on the finder window 404, and the window is opened. A user looks in the finder window 404, but no harmful light enters into the finder 400 from the finder window 404, and any harmful light that might enter is so slight as to be negligible.

In FIG. 5(b), the preview operation is executed, and since the shutter 302 is open, the image sensor 303 normally captures an image. The stop of the optical stop 202 is fixed in the open position, and the exposure time is adjusted by the electronic shutter (not shown in the drawing) based on the sensed image signal level. The processed image is normally displayed on the display monitor 304 on the back side of the camera. At this time, since the main switch 503a is set at the preview position to specify the electronic monitor mode, the end 2f of the arm 2a received a lifting force by the contact 2d. Accordingly, the arm 2a is driven in rotation in a counterclockwise direction in the drawing about the pivot point 2e against the tension of the spring 2c, and the shield 2b overlaps the finder window 404 to close the window. As a result, harmful light is cut from the finder window 404.

FIG. 5(c) shows the exposure of the image sensor 303 when the shutter button is pressed in the electronic monitor mode, via the main exposure in the state shown in FIG. 5(b).

Second Embodiment

The first embodiment described above opens and closes the eyepiece shutter 2 by setting or not setting the preview mode via the main switch 503a. Since normally the eyepiece shutter 2 is open when use of the optical finder is selected, there is concern that harmful light from the finder window 404 may enter through the finder 400 to the image sensor 303 during photographic exposure. Normally, since the user looks through the finder window 404 during exposure when the optical finder is used, scant harmful light is considered to enter from the finder window 404. However, this is not true when the self timer is used or during remote mode photography. The second embodiment reliably prevents harmful light from entering in these instances.

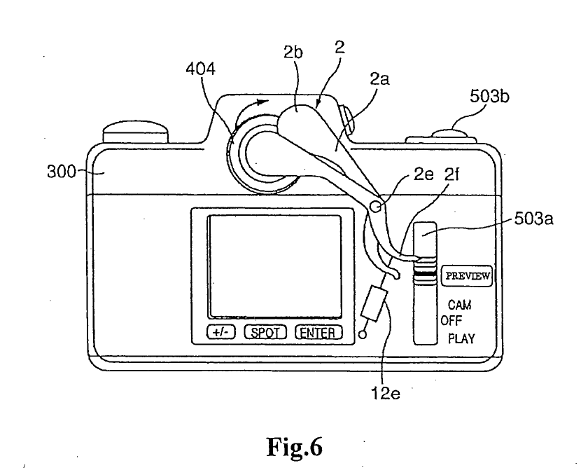

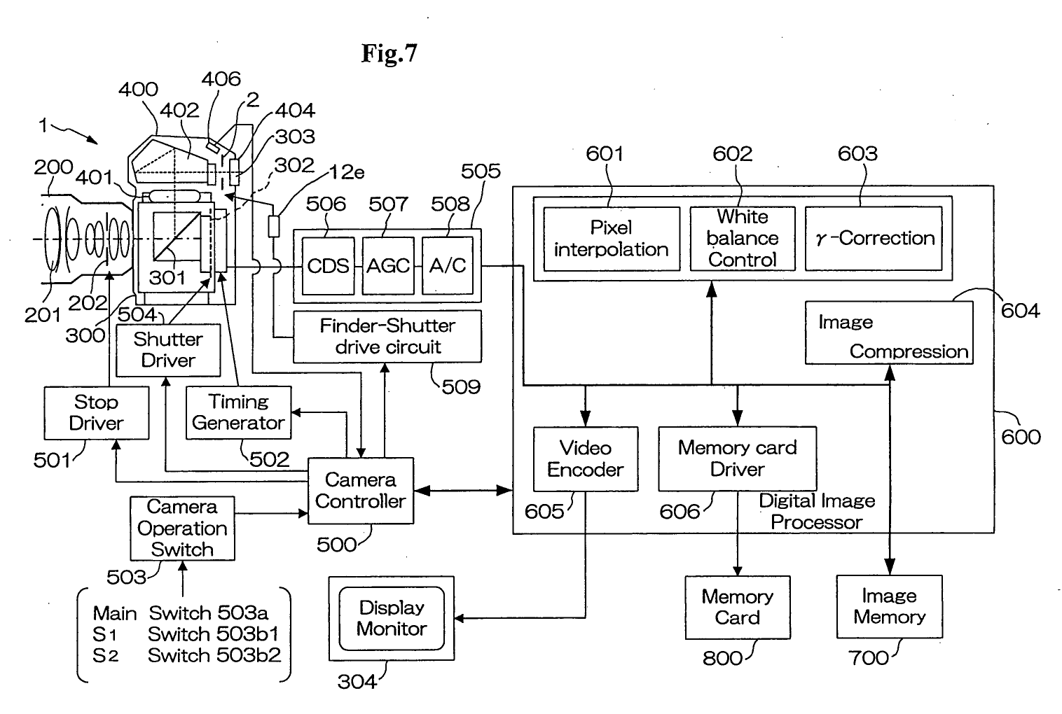

FIG. 6 shows the eyepiece shutter mechanism of the digital camera 1 of the second embodiment. In FIG. 6, in contrast to FIG. 3, the contact 2d is eliminated, and the main switch 503a and the eyepiece shutter 2 are not mechanically linked. A solenoid 12e is provided in substitution for the spring 2c, and the tip of the plunger of the solenoid 12e is connected to the base end 2f (end on the acting point side) of the arm 2a. When the main switch 503a is set at the preview position, the solenoid 12e is controlled so as to extend the plunger by the camera controller 500 via the finder shutter drive circuit 509 (refer to FIG. 7). On the other hand, the main switch 503a is set at a position other than the preview position, the solenoid 12e is controlled so as to retract the plunger. When the main switch 503a is set at the CAM position and the shutter button 503b is completely depressed so as to turn ON the S2 switch 503b2, the solenoid 12e is controlled so as to extend the plunger until exposure is completed. That is, when the electronic monitor mode is not set, the eyepiece shutter 2 is set at the open position. Conversely, when the optical finder mode is set, the eyepiece shutter 2 is set to the shield position at least during the exposure period, so as to prevent harmful light from entering from the finder window 404 to the image sensor 303. In the digital camera 1 of the second embodiment, the eyepiece shutter 2 electrically opens and closes the shutter part in accordance with the various positions of the main switch 503a as described above.

FIG. 7 is a block diagram of the photographic process of the digital camera 1 of the second embodiment.

In FIG. 7, part in common with FIGS. 1˜3 and FIG. 6 are designated by like reference numbers. In FIG. 7, the camera controller 500 intensively controls the photographic operation of the digital camera 1. In the present embodiment, camera controller 500 controls the finder shutter drive circuit 509 in addition to the operations described in the first embodiment. The finder shutter drive circuit 509 controls the operation of opening and closing the eyepiece shutter 2 via the solenoid 12e based on instructions from the main switch 503a, S1 switch 503b1, and S2 switch 503b2. When the main switch 503a is set at the preview position, the plunger of the solenoid 12e is extended by the camera controller 500 via the finder shutter drive circuit 509. On the other hand, when the main switch 503a is set at a position other than the preview position, the solenoid 12e is controlled so as to retract the plunger. When the main switch 503a is set at the CAM position and the shutter button 503b is completely depressed to turn ON the S2 switch 503b2, the solenoid 12e is controlled so as to extend the plunger until the exposure is completed.

The operation of the eyepiece shutter is described below.

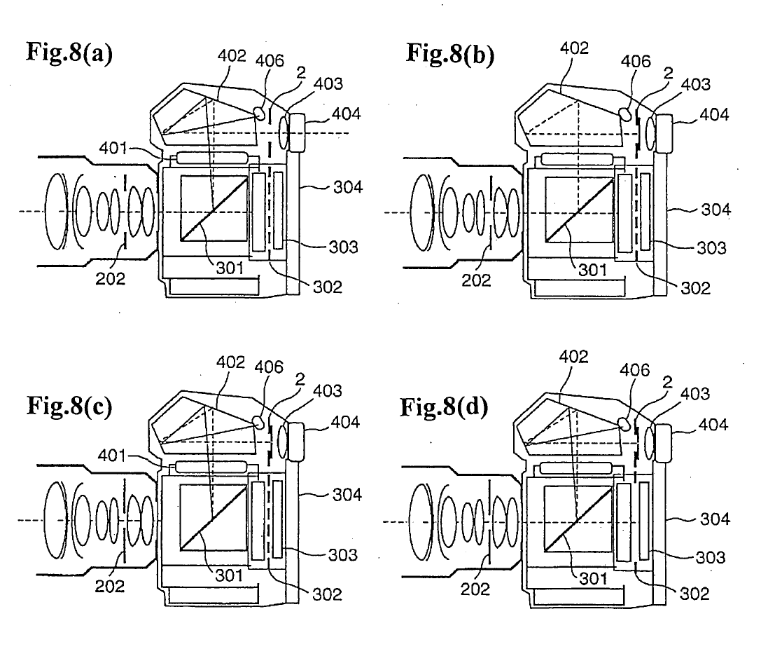

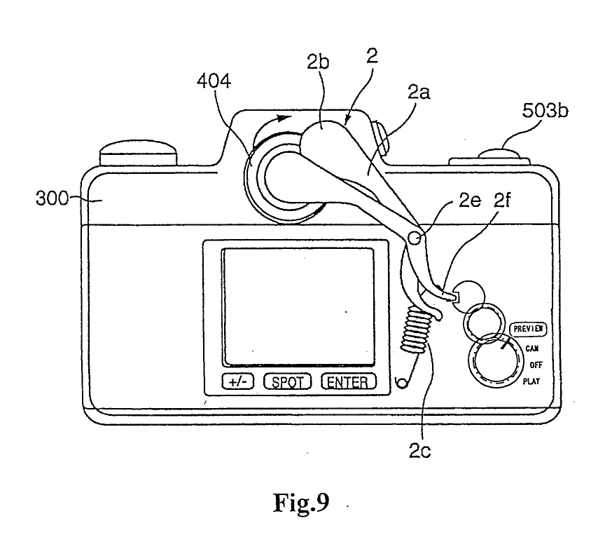

FIG. 8 shows the various operations of the optical finder mode in the second embodiment. FIG. 8(a) shows the operation when the S1 switch is ON. FIGS. 8(b) and 8(c) show the operation when the S2 switch is ON. FIG. 8(d) shows the operation after the S2 switch is turned ON. FIG. 8 shows the opening and closing of the eyepiece shutter 2 in the finder 400 in connection with photography.

FIG. 8(a) illustrates when the S1 switch is turned ON; the shutter 302 is closed, and the image sensor 303 is stopped. Part of the object image light split by the mirror 301 enters the image sensor 303, and the remaining image light is reflected by the mirror 301 and forms an image on the focusing screen 401. The formed image is reflected by the prism 402, and the amount of light is measured by the photometric sensor 406, and directed to the finder window 404 through the eyepiece optical system 403. At this time, the main switch 503a is set at the CAM position as shown in FIG. 6, and the S1 switch 503b1 (refer to FIG. 7) is turned ON by depressing the shutter button 503b halfway, the plunger of solenoid 12e is retracted. Accordingly, the arm 2a is driven in rotation in a clockwise direction in the drawing about the pivot point 2e via the retraction of the plunger connected to the end 2f of the arm 2a. As a result, the shield 2b is removed from overlapping the finder window 404 and the finder window 404 is opened. A user looks in the finder window 404, but no harmful light enters into the finder 400 from the finder window 404, and any harmful light that might enter is so slight as to be negligible.

FIGS. 8(b) and 8(c) illustrate when the S2 switch (refer to FIG. 7) is turned ON by completely depressing the shutter button 503b to specify photography with the main switch 503a set at the CAM position. At this time, the plunger of the solenoid 12e is extended. Accordingly, the arm 2a is driven in rotation in a counterclockwise direction in FIG. 6 about the pivot point 2e via the extension of the plunger connected to the end 2f of the arm 2a. As a result, the shield 2b is overlaid on the finder window 404, and the window is closed such that harmful light is cut. When the stop of the optical stop 202 is set at a predetermined value, at the same time the photometric sensor 406 again measures the amount of light without influence by harmful light, and the exposure is set.

FIG. 8(d) shows the main exposure via the image sensor 303 when the shutter 302 is open.

In the first and second embodiments as described above, the finder window 404 is shielded when using the display monitor 304 for preview and the like. Accordingly, harmful light entering from the finder window 404 does not reach the image sensing surface of the image sensor 303 and does not adversely affect the quality of the monitor image on the display monitor 304.

Even when the object is photographed while being confirmed on the display monitor 304, the finder window 404 is shielded during the exposure of the image sensor 303. Accordingly, harmful light entering from the finder window 404 does not reach the image sensing surface and does not adversely affect the quality of the photographic image, such that exposure errors do not occur.

In the first and second embodiment described above, the eyepiece shutter 2 is disposed between the prism 402 and the eyepiece optical system 403 within the finder 400, the eyepiece shutter 2 also may be disposed elsewhere in the finder optical system. From the perspective of shield light, it is desirable to provide the eyepiece shutter 2 near the finder window 404. Such disposition is effective and allows the shutter diameter to be reduced.

In the first and second embodiment, a half mirror and prism are used as mirror 301, but a quick-return mirror also may be used. However, when a quick-return mirror is used, harmful light from the optical finder cannot be completely shielded due to lifting of the mirror during exposure. Accordingly, the eyepiece shutter 2 is required.

In the first and second embodiments described above, the main switch 503a selects both power ON/OFF and RECORD/PLAY modes. But it is to be noted that separate switches may be provided to select power ON/OFF and RECORD/PLAY modes. For example, one slide switch might have three positions of REC, OFF, PLAY, and another slide switch might have two positions of preview and CAM. Furthermore, main switch 503a need not necessarily be movable in vertical directions for operation, inasmuch as the slide switch may slide laterally or other optional direction. The main switch 503a need not necessarily be a slide switch, and may be, for example, a dial-type switch. In the case of a dial-type switch, a rotation mechanism such as a gear or the like is used in substitution for the oscillation mechanism described above as the movement transmitting means of the eyepiece shutter 2 as shown in FIG. 9.

As described above, there is no concern that harmful light from the finder window will enter the image sensor to adversely affect the quality of the monitor image. Even during exposure, harmful light from the finder window does not adversely affect the quality of the photographic image, and exposure errors do not occur.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

1. A digital camera comprising:
an image sensor for sensing an object image;
an eyepiece for viewing an object;
a display for displaying an object image sensed by said image sensor;
a selector for selecting a mode for viewing on object on said display;
a shield member for shielding said eyepiece; and
a controller for moving said shield member to block the eyepiece when a mode is selected via said selector to view an object on said display.

2. The digital camera according to claim 1, wherein said selector is a slide switch and said controller includes a movement transmitting member which moves said shield member between an eyepiece open position and an eyepiece closed position in conjunction with a sliding movement of said slide switch.

3. The digital camera according to claim 2, wherein said movement transmitting member includes a contact member fixedly attached to a sliding part of said slide switch; an arm, one end of which contacts and is driven by the contact member and the other end of which moves said shield member; and a spring for imparting a force on said arm in a direction of contact with said contact member.

4. The digital camera according to claim 1, wherein said selector is a dial-type switch and said controller includes a rotation mechanism.

5. The digital camera according to claim 1, further comprising a detector for detecting the exposure period of the image sensor, wherein said controller controls the opening and closing of a shield member so as to block the eyepiece during the exposure period detected by said detector.

6. The digital camera according to claim 1, further comprising a driver for controlling the position of the shield member.

7. The digital camera according to claim 1, wherein said driver includes a solenoid.

8. A digital camera comprising:
a mirror to reflect part of the object image light and transmit the remaining light;
a finder to capture part of the reflected light and including an eyepiece unit;
an image sensor to capture and photoelectrically convert the remaining transmitted light to image signals;
a display monitor for displaying said image signals captured by said image sensor as a display image; and
an eyepiece shutter for shielding said eyepiece unit of said finder when said display monitor is used.

9. The digital camera according to claim 8, further comprising:
a selector for selecting a mode for viewing on object on said display monitor; and
a controller controlling said eyepiece shutter to block the eyepiece unit when a mode is selected via said selector to view an object on said display.

10. The digital camera according to claim 9, wherein said selector is a slide switch and said controller includes a movement transmitting member which moves said shutter between an eyepiece unit open position and an eyepiece unit closed position in conjunction with a sliding movement of said slide switch.

11. The digital camera according to claim 10, wherein said movement transmitting member includes a contact member fixedly attached to a sliding part of said slide switch; an arm, one end of which contacts and is driven by the contact member and the other end of which moves said shutter; and a spring for imparting a force on said arm in a direction of contact with said contact member.

12. The digital camera according to claim 8, wherein said selector is a dial-type switch and said controller includes a rotation mechanism.

13. The digital camera according to claim 8, further comprising a detector for detecting the exposure period of the image sensor, wherein said controller controls the opening and closing of a shutter so as to block the eyepiece unit during the exposure period detected by said detector.

14. The digital camera according to claim 8, further comprising a driver for controlling the position of the shutter.

15. A digital camera comprising:
an image sensor for sensing an object image;
an eyepiece for viewing an object;
a display for displaying an object image sensed by said image sensor;
a detector for detecting when said image sensor is undergoing exposure to said object image;
a shield member for shielding said eyepiece; and
a controller for moving said shield member to block the eyepiece when said detector detects said exposure.

16. The digital camera according to claim 15, further comprising a slide switch and said controller includes a movement transmitting member which moves said shield member between an eyepiece open position and an eyepiece closed position in conjunction with a sliding movement of said slide switch.

17. The digital camera according to claim 16, wherein said movement transmitting member includes a contact member fixedly attached to a sliding part of said slide switch; an arm, one end of which contacts and is driven by the contact member and the other end of which moves said shield member; and a solenoid for imparting a force on said arm in a direction of contact with said contact member.
